(19) United States
(12) Patent Application Publication
(10) Pub. No.: US 2011/0023505 A1
(43) Pub. Date: Feb. 3, 2011

(54) Refrigeration systems for blended iced beverage machines

(76) Inventors: Nikolay Popov, Naperville, IL (US); Santhosh Kumar, Naperville, IL (US); Douglas Anderson, St. Charles, IL (US)

Correspondence Address: PYLE & PIONTEK LLC, 221 N. LASALLE STREET, SUITE 1207, CHICAGO, IL, 60601, US

(21) Appl. No.: 12/803,224

(22) Filed: Jun. 22, 2010

Related U.S. Application Data
(60) Provisional application No. 61/269,361, filed on Jun. 24, 2009.

(51) Int. Cl. F25D 17/06; F25C 5/18; F28F 3/12; F28D 15/00; F25D 17/02; A23P 1/00; A23L 2/38

(52) U.S. Cl. 62/89; 62/344; 165/170; 165/104.28; 62/419; 62/118

(57) ABSTRACT

Refrigeration systems for machines for making blended iced beverages make ice for use in the beverages and maintain beverage ingredients cold not only as the ingredients are stored in supply containers in the machine but also as they are delivered from the supply containers to a remote point of delivery at a beverage ingredient dispense station. Arrangements are disclosed in which a single refrigeration system makes ice and chills the beverage ingredients; in which a pair of refrigeration systems make ice and chill the beverage ingredients; in which a single refrigeration system makes ice and the ice is used to chill the beverage ingredients; and in which a single refrigeration system makes ice and melt water from the ice is used in chilling the beverage ingredients.

This application claims benefit of provisional application Ser. No. 61/269,361, filed Jun. 24, 2009.

### BACKGROUND OF THE INVENTION

The present invention relates to machines for making blended iced beverages, and in particular to refrigeration systems for such machines.

Machines for mixing and dispensing iced beverages are known. In recent years, beverages comprising fruit juice, fruit drink and/or beverage syrup that are blended with water and ice have become popular. If the beverage includes ice cream or yoghurt, it is called a smoothie, which is a non-carbonated drink that usually contains fruit or a mixture of different fruits that, along with crushed or shaved ice, are pulverized by a blender to almost liquid form and served at a freezing temperature to include ice crystals. A customary method of preparing a smoothie is to place the beverage ingredients in a container and then blend the ingredients to a point where the ice is pulverized and evenly dispersed throughout the resulting beverage product.

Smoothie making machines normally include a lower housing portion for storage of supplies of beverage ingredients and an upper housing portion for holding a supply of ice for use in the preparation of smoothie beverages, which ice may be manufactured by an integrated icemaker and refrigeration system. A beverage ingredient dispense station is at a front of the upper housing portion, along with a beverage ingredient blending station and, desirably, a rinsing station for cleaning containers used in the mixing and blending of beverages for service to customers. Beverage ingredients, which can include beverage syrup concentrate, fruit juice, fruit drink and water are delivered through tubing bundles from supplies thereof in the lower cabinet to the dispensing station at the upper cabinet, and ice also is delivered to the dispensing station from a supply of ice usually contained in a bin in the upper cabinet. Means are provided for crushing or shaving the ice and for metering the amounts of ice, water and beverage ingredients delivered from the beverage dispensing station into a mixing container, in accordance with the type and size of beverage to be prepared.

For proper consistency and quality, the smoothie served to a customer should be at freezing temperature and include ice crystals. This requires that the water and beverage ingredients delivered to the dispensing station be sufficiently cold, since otherwise the ice portion of the beverage will melt excessively when mixed with the water and other beverage ingredients, degrading the quality of the smoothie beverage. More importantly, since an ingredient of a smoothie is a perishable dairy product such as milk or yogurt, which can spoil if not kept sufficiently cold, National Sanitation Foundation standards require that the dairy product be kept sufficiently chilled, both in storage and as delivered to the dispensing station. Refrigeration systems and beverage ingredient chilling techniques used with conventional machines for making iced beverages are not well equipped to provide such chilling of beverage ingredients. Consequently, when a conventional iced beverage making machine is idle for an extended period of time, it can happen that the beverage ingredients that have been delivered to a point intermediate the beverage ingredient supplies and beverage ingredient dispense station can warm to a temperature well above freezing, resulting in spoilage and/or a degradation in quality of the beverage that ends up being made from such warm ingredients.

### OBJECT OF THE INVENTION

A primary object of the present invention is to provide improved refrigeration systems for machines for making blended iced beverages, which systems ensure that beverage ingredients are always delivered in a properly chilled and unspoiled state to a beverage ingredients dispense station.

### SUMMARY OF THE INVENTION

In accordance with the present invention, an apparatus for making blended iced beverages comprises a housing including an upper cabinet having an ice storage bin and a beverage ingredient dispense station, a lower cabinet for storing supplies of beverage ingredients and a conduit extending between the lower cabinet and a point of delivery of beverage ingredients in the upper cabinet; an icemaker; means for delivering beverage ingredients from supplies thereof in the lower cabinet through the conduit to the point of delivery in the upper cabinet; and a refrigeration system for operating the icemaker to make ice for the bin and also for chilling both the lower cabinet and the means for delivering along its path from the beverage ingredient supplies and through the conduit to the point of delivery, so that beverage ingredients are chilled and maintained chilled as they are delivered from the beverage ingredient supplies to the point of delivery.

In one embodiment the refrigeration system comprises a cold plate in heat exchange relationship with ice in the bin, a heat exchanger in the lower cabinet, a closed-loop fluid re-circulation circuit that includes at least one circuit of the cold plate and at least one circuit of the heat exchanger, and a pump for circulating a heat transfer fluid through the closed-loop circuit to chill the fluid as it passes through the cold plate circuit and to then chill the heat exchanger as the fluid passes through the heat exchanger circuit, so that the heat exchanger chills the lower cabinet and the supplies of beverage ingredients in the lower cabinet.

The refrigeration system may include means for moving chilled air from the lower cabinet through the conduit to chill the means for delivering in the conduit.

The means for delivering can comprises a tubing bundle and the closed-loop circuit can be heat transfer coupled to the tubing bundle to chill beverage ingredients delivered thereby.

It is contemplated that the refrigeration system can comprise an evaporator for chilling air in the lower cabinet and means for moving chilled air from the lower cabinet through the conduit to chill the means for delivering.

It also is contemplated that the refrigeration system can comprise an evaporator in the lower cabinet for chilling air therein to chill the supplies of beverage ingredients, a heat exchanger having at least one fluid circuit, means for moving air chilled by the evaporator through the heat exchanger, a closed-loop heat transfer re-circulation circuit that includes the at least one circuit of the heat exchanger and a pump for circulating a heat transfer fluid through the closed-loop circuit, and that the means for delivering can include a tubing bundle extending from the supplies of beverage ingredients in the lower cabinet and through the conduit to the point of delivery. In this case, the closed-loop circuit is heat transfer coupled to the tubing bundle within the conduit to chill the tubing bundle and beverage ingredients therein, so that chilled beverage ingredients are delivered from the supplies thereof and through the conduit to the point of delivery.

In a further contemplated embodiment of the apparatus, the refrigeration system comprises a cold plate chilled by ice in the bin and having at least one fluid circuit, a heat exchanger for chilling the lower cabinet and having at least one fluid circuit, and a closed-loop fluid re-circulation circuit that includes the at least the one fluid circuit of the cold plate and the at least one fluid circuit of the heat exchanger and a pump for circulating a heat transfer fluid through the closed-loop circuit. Here, the means for delivering includes a tubing bundle extending between the supplies of beverage ingredients in the lower cabinet and through the conduit to the point of delivery and the closed-loop circuit is heat transfer coupled to the tubing bundle to chill the tubing bundle and beverage ingredients therein, so that chilled beverage ingredients are delivered from the supplies thereof to the point of delivery.

In another embodiment of the apparatus, the refrigeration system comprises a coil that is heat transfer coupled to ice in the bin, a heat exchanger for chilling the lower cabinet and having at least one fluid circuit, and a closed-loop fluid circulation circuit that includes the coil, the at least one circuit of the heat exchanger and a pump for circulating a heat transfer fluid through the closed-loop circuit. In this case, the means for delivering can comprise a tubing bundle extending between supplies of beverage ingredients in the lower cabinet and through the conduit to the point of deliver and the closed-loop circuit is heat transfer coupled to the tubing bundle to chill the tubing bundle and beverage ingredients therein, so that chilled beverage ingredients are delivered from the supplies thereof to the point of delivery.

In a still further embodiment of the apparatus the refrigeration system comprises first and second refrigeration systems. The first refrigeration system is for operating the icemaker and includes a heat exchanger having at least one refrigerant flow circuit in-line with a refrigerant flow path from the icemaker for chilling of the heat exchanger, together with a fan for circulating air between the heat exchanger and the conduit to chill the conduit and the beverage ingredient delivering means in the conduit. The second refrigeration system has an evaporator for chilling the lower cabinet and the supplies of beverage ingredients in the cabinet, whereby beverage ingredients are maintained chilled as they are delivered from the supplies thereof to the point of delivery.

The invention further contemplates an apparatus in which the means for delivering beverage ingredients includes a tubing bundle extending between the supplies of beverage ingredients and the point of delivery, and in which the refrigeration system includes an ice melt water drain line that is heat transfer coupled to the tubing bundle to chill beverage ingredients in the tubing bundle.

The invention also provides a method of refrigerating a blended iced beverage making machine that has an upper cabinet having an ice storage bin and a beverage ingredient dispense station, a lower cabinet for storing supplies of beverage ingredients, a conduit extending between the lower cabinet and a point of delivery of beverage ingredients in the upper cabinet, and an icemaker for making ice for the bin. The method comprises the steps of delivering beverage ingredients from the supplies thereof in the lower cabinet through the conduit to the point of delivery in the upper cabinet; operating the icemaker to make ice for the bin; and refrigerating the lower cabinet and the beverage ingredients as they are delivered from the lower cabinet through the conduit to the point of delivery, so that chilled beverage ingredients are delivered to the point of delivery.

In one embodiment of the method, the refrigerating step comprises the steps of placing a cold plate in heat exchange relationship with ice in the bin; placing a heat exchanger in the lower cabinet; and flowing a heat transfer fluid through a closed-loop fluid re-circulation circuit that includes at least one circuit of the cold plate and at least one circuit of the heat exchanger to chill the fluid as it passes through the cold plate circuit and to then chill the heat exchanger as the fluid passes through the heat exchanger circuit, whereby the heat exchanger chills the lower cabinet and the supplies of beverage ingredients in the lower cabinet.

The refrigeration step can comprise the step of moving chilled air from the lower cabinet through the conduit to chill the beverage ingredients within and as they are delivered through the conduit. The delivering step can comprise the step of delivering beverage ingredients through a tubing bundle, and the refrigeration step can include the step of heat transfer coupling the closed-loop re-circulation circuit to the tubing bundle to chill beverage ingredients delivered therethrough.

In another contemplated practice of the method, the refrigeration step comprises the steps of chilling air in the lower cabinet, and moving chilled air from the lower cabinet through the conduit to chill beverage ingredients within and being delivered through the conduit to the point of delivery.

It is contemplated that the delivering step can include the step of flowing beverage ingredients through a tubing bundle that extends from the supplies of beverage ingredients in the lower cabinet and through the conduit to the point of delivery, and that the refrigeration step comprises the steps of chilling air in the lower cabinet to chill the supplies of beverage ingredients, using chilled air in the lower cabinet to chill a heat exchanger, flowing a heat transfer fluid through a closed-loop re-circulation circuit that includes a circuit of the heat exchanger, and heat transfer coupling the closed-loop heat transfer circuit to the tubing bundle to chill the tubing bundle and thereby beverage ingredients delivered through the tubing bundle to the point of delivery.

In a further practice of the method, the delivering step includes the step of delivering beverage ingredients from the supplies thereof to the point of delivery through a tubing bundle that extends through the conduit, and the refrigeration step includes the steps of placing a cold plate in heat exchange relationship with ice in the bin, providing a heat exchanger for chilling the lower cabinet, and establishing a closed-loop fluid re-circulation circuit that includes at least the one fluid circuit of the cold plate, at least one fluid circuit of the heat exchanger and at least one tubing of the tubing bundle to chill the tubing bundle.

The method of the invention also contemplates that the delivering step includes the step of delivering beverage ingredients from the supplies thereof to the point of delivery through a tubing bundle that extends through the conduit, and that the refrigeration step includes the steps of heat transfer coupling a coil to ice in the bin, providing a heat exchanger for chilling the lower cabinet, establishing a closed-loop fluid re-circulation circuit that includes the coil and at least one circuit of the heat exchanger, and heat transfer coupling the closed-loop circuit to the tubing bundle to chill the tubing bundle

It further is contemplated that the delivering step includes the step of delivering beverage ingredients from the supplies thereof to the point of delivery through a tubing bundle that extends through the conduit, and that the refrigeration step includes the step of heat transfer coupling an ice melt water drain line to the tubing bundle to chill beverage ingredients in the tubing bundle.

### BRIEF DESCRIPTION OF THE DRAWINGS

FIG. 1 is a pictorial representation of an apparatus or machine for preparing blended iced beverages, such as a smoothie making machine, of a type with which refrigeration systems for chilling beverage ingredients and embodying the teachings of the invention may advantageously be used;

FIG. 2 is a schematic representation of such a smoothie machine that uses a refrigeration system according to a first embodiment of the invention;

FIG. 3 is a schematic representation of such a machine that has a refrigeration system according to a second embodiment of the invention;

FIG. 4 is a schematic representation of such a machine that utilizes a refrigeration system according to a third embodiment of the invention;

FIG. 5 is a schematic representation of such a machine that incorporates a refrigeration system according to a fourth embodiment of the invention;

FIG. 6 is a schematic representation of such a machine that has a refrigeration system according to a fifth embodiment of the invention;

FIG. 7 is a schematic representation of such a machine that embodies a refrigeration system according to a sixth embodiment of the invention; and

FIG. 8 is a schematic representation of such a machine that includes a refrigeration system according to a seventh embodiment of the invention.

### DETAILED DESCRIPTION

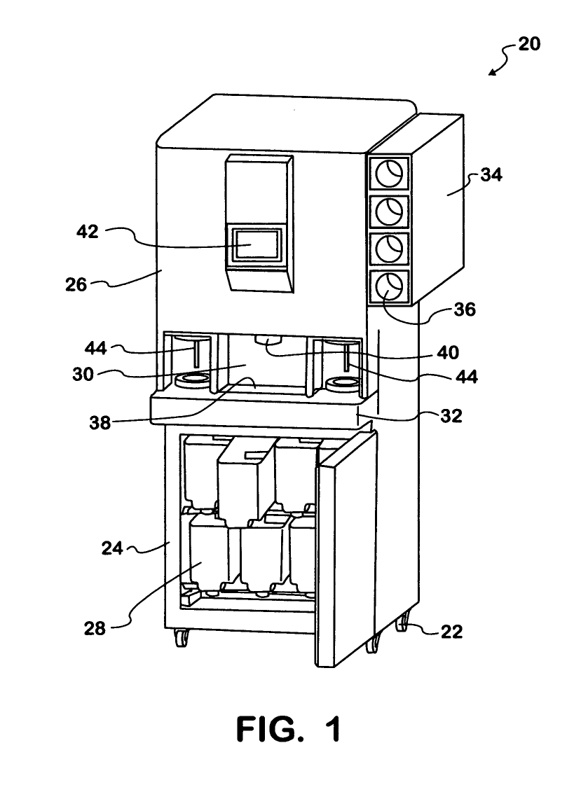

An apparatus or machine for preparing blended iced beverages, such as a smoothie making machine, is shown in FIG. 1 and indicated generally at 20. The machine is adapted to sit on a floor of a food service establishment and may have casters 22 that facilitate its movement on the floor. The machine has a lower housing or cabinet portion 24 and an upper housing or cabinet portion 26. The lower cabinet 24 is for receiving and storing a plurality of supply containers 28 of beverage ingredients, that may include dairy products such as milk and/or yogurt as well as fruit juices, fruit drinks, beverage syrups and water. A refrigeration system (not shown in FIG. 1) is provided for chilling the lower cabinet and supplies of beverage ingredients in the cabinet.

The upper cabinet 26 contains an ice storage area that may be provided by a bin or hopper (not shown in FIG. 1), along with an icemaker coupled to the refrigeration system for manufacturing and introducing ice into the bin, all in a manner well understood by those of skill in the art. A beverage ingredients dispensing station 30 is at a lower front of the upper cabinet 26 and a shelf 32 is between the lower and upper cabinets 24 and 26. A cup dispenser 34 may be mounted to the side of the machine 20 and holds a plurality of dispensable cups 36 of different sizes.

To prepare a blended iced beverage for service to a customer, a container (not shown in FIG. 1) in which the beverage is to be prepared is placed on a grate 38 at the beverage ingredients dispensing station 30. Liquid beverage ingredients from the beverage ingredient supply containers 28 in the lower cabinet 24 are then delivered through a tubing bundle to inlets to associated valves (neither shown in FIG. 1), outlets from which valves are located above the beverage ingredients dispense station 30. An outlet from an ice dispense chute 40 is also located above the beverage ingredients dispense station, so that with the container in place at the station it is positioned to receive beverage ingredients dispensed by the valves and ice dispensed from the ice dispense chute. A user interface 42 on a front face of the machine upper cabinet 26 is coupled to a controller (not shown) for the valves and ice chute and has user actuable switches that control the valves and ice chute, so that operator selected beverage ingredients for preparing a desired blended iced beverage are dispensed into the container.

To control the quantities of beverage ingredients that are dispensed into a container, the valves may be actuated for selected times or fluid flow meters may be used. To control the quantity of ice dispensed into the container, an ice portion control of a type as disclosed in U.S. Pat. No. 4,921,149 may be used, the teachings of which patent are incorporated herein by reference. In essence, to dispense a predetermined quantity of ice, a gate at a lower end of the ice chute 40 is closed while the chute is filled with ice, which may be ice that has been crushed or shaved. The gate is then opened for a time selected such that the predetermined quantity of ice gravitationally flows out of the chute and into the container before the gate is again closed. If desired, fruit can be manually added to beverage ingredients in the container.

After selected predetermined quantities of beverage ingredients are introduced into a container at the dispense station 30, the container is moved to one of two blending and rinsing stations 44 on the front of the smoothie machine 20 to opposite sides of the dispense station. Each blending rinsing station 44 includes means for blending the beverage ingredients in the container to produce a blended iced beverage, which blending means can include an agitator at the station that is extendable into the beverage ingredients in the container for blending the ingredients. Alternatively, the container can itself include an agitator that is coupled with drive means at the blending and rinsing station to blend the ingredients. After the ingredients are blended, they are poured from the container into a cup obtained from the cup dispenser 34 for service to a customer. The container is then returned to one of the blending and rinsing stations, which include means for rinsing and cleaning the container to ready it for use in preparing of the next blended iced beverage. Alternatively, the container in which the beverage is prepared and blended can be the cup in which the beverage is served to a customer, in which case there would be no need to use and clean a separate container in which the beverage is prepared and blended for transfer to a customer's cup.

Ideally, the resulting smoothie will have been pulverized by the blender to almost liquid form and served at a freezing temperature to include ice crystals. For this quality standard to be met, it is necessary that the beverage ingredients be sufficiently cold, both as stored in the lower cabinet 24 and as delivered to the beverage ingredient dispense station 30, since if the beverage ingredients are not kept sufficiently cold, the ice portion of the beverage will melt excessively, resulting in a thin beverage that does not have ice crystals. Also and more importantly, if a smoothie is to be prepared, then since an ingredient of a smoothie is a perishable dairy product such as milk or yogurt, which can spoil if not kept sufficiently cold, National Sanitation Foundation standards require that the dairy product be kept sufficiently chilled, both in storage and as delivered to the dispense station. The invention therefore contemplates refrigeration systems for continuously maintaining the beverage ingredients at a properly cold temperature both as stored in the lower cabinet 24 and as delivered to the point of delivery at the beverage ingredient dispense station 30.

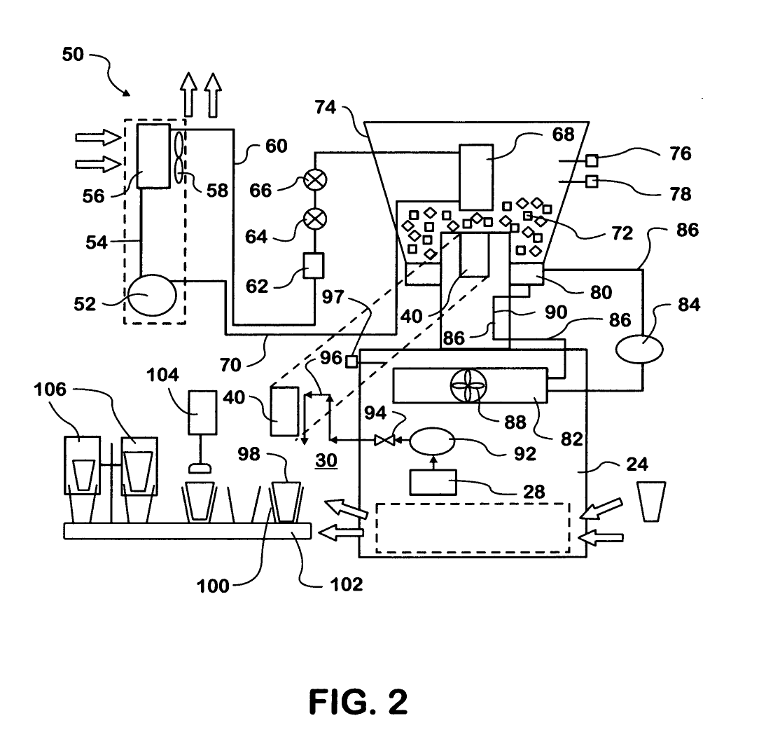

FIG. 2 shows a first embodiment of refrigeration system contemplated by the invention, indicated generally at 50 and for maintaining beverage ingredients cold both as stored in the lower cabinet 24 and as delivered from the lower cabinet to the point of delivery at the beverage ingredient dispense station 30. In this as in subsequent Figs., arrows indicate the directions of air flows and the refrigeration system includes a compressor 52, hot refrigerant at a high pressure outlet from which flows through a refrigerant line 54 to a condenser 56 through which air is drawn by a fan 58 to cool the refrigerant. Cooled refrigerant exiting the condenser flows through a refrigerant line 60, a filter/dryer 62, a solenoid valve 64 and an expansion valve 66 to an inlet to an evaporator 68 of an icemaker, and refrigerant exiting the evaporator returns through a refrigerant line 70 to a suction inlet to the compressor 52. The icemaker builds ice pieces 72 that are introduced into and stored in an ice bin 74 in the upper cabinet 26 of the machine 20. An upper thermostat 76 and a lower thermostat 78 sense the level of ice in the bin and control operation of the compressor 52 in a manner to maintain the level of ice between the levels of the thermostats. The arrangement is such that the compressor 52 is operated to make ice for the bin until the level of ice in the bin reaches the level of the upper thermostat 76. The compressor is then turned off until the level of ice in the bin falls to the level of the lower thermostat 78, whereupon the compressor is turned back on and the cycle is repeated.

For proper consistency and quality of a smoothie beverage served to a customer and to prevent spoilage of beverage ingredients, particularly any comprising dairy products, the ingredients are advantageously maintained sufficiently cold both in storage in the lower cabinet 24 and as delivered to beverage dispense valves at the point of delivery above the dispense station 30. Maintaining beverage ingredients sufficiently cold is accomplished in the FIG. 2 embodiment by providing a cold plate 80 in a lower part of the ice storage bin 74 and a heat exchanger 82 in the lower cabinet 24, and by heat transfer coupling the cold plate and heat exchanger, so that ice 72 in the bin, which chills the cold plate, also is used to chill the heat exchanger. In particular, a closed-loop heat transfer fluid re-circulation circuit heat transfer couples the cold plate 80 and the heat exchanger 82. The circuit includes a pump 84 that circulates a heat transfer fluid, which may be water, through a closed-loop circuit that includes lines 86 extending between and connecting at least one fluid circuit in the cold plate 80 and at least one fluid circuit in the heat exchanger 82, whereby heat transfer fluid that gives up heat and is chilled as it flows through the cold plate picks up heat and is warmed as it flows through the heat exchanger to chill the heat exchanger. A fan 88 moves air through the chilled heat exchanger to chill air in the lower cabinet 24 to maintain the beverage ingredient supplies 28 cold. The fan also moves cold air from the heat exchanger 82 into and through a conduit 90 extending between the lower cabinet 24 and the point of delivery of beverage ingredients at and above the beverage ingredients dispense station 30. Beverage ingredients are delivered from the lower cabinet 24 and through the conduit 90 to the point of delivery at the beverage ingredients dispense station 30 by pumps 92, valves 94 and tubing 96 associated with the beverage ingredient supplies 28 (only one of each being shown), which are located within either the lower cabinet or the conduit, so that the cold air in the lower cabinet and conduit maintains the beverage ingredients in a continuously cold state until they are dispensed, even upon the beverage making machine 20 sitting idle for an extended period. The tubing 96 through which the beverage ingredients are delivered may be part of a tubing bundle or python extending from the lower cabinet 24 and through the conduit 90 to the point of delivery, and it also is contemplated that the recirculation line 86 extend through the python in heat transfer relationship with the tubing conveying the beverage ingredients in the python in order to further maintain the ingredients chilled. Further, chilled water in the recirculation line 86 can be fluid coupled to a water dispense valve at the point of delivery in order to flow water chilled by the cold plate 80 directly to the point of delivery for being dispensed in preparation of a beverage. A thermostat 97 senses the temperature in the lower cabinet 24 and controls operation of the pump 84 to maintain a selected temperature within the cabinet.

At the dispense station 30, metered quantities of cold beverage ingredients and ice are dispensed into a beverage preparation container 98 supported in a holder 100 carried on and moved by a conveyor 102. After beverage ingredients and ice are dispensed into the container, the conveyor moves the container to a blending station where beverage ingredients and ice are blended by a blender 104 to provide an iced beverage that is almost liquid in form and includes ice crystals. The blended beverage is then moved by the conveyor to a cup holder station 106 where it is transferred from the container 98 into a cup of selected size for service to a customer. The cup may be manually obtained from the cup dispenser 34 or may be automatically delivered to the cup holder station.

In the FIG. 2 embodiment of refrigeration system 50, chilling of the supplies 28 of beverage ingredients in the lower cabinet 24 and of beverage ingredients as delivered from the lower cabinet into and through the conduit 90 to the point of delivery is accomplished by the use of ice 72 in the bin 74, which ice also is delivered from the bin into the ice chute 40 for being dispensed in metered quantities into containers 98 in the preparation of a blended iced beverages. If desired, the compressor 52, condenser 56 and fan 58 can be located in a separate compartment in the bottom of the lower cabinet, as shown by the dashed line rectangle, or they can be carried atop the upper cabinet 26.

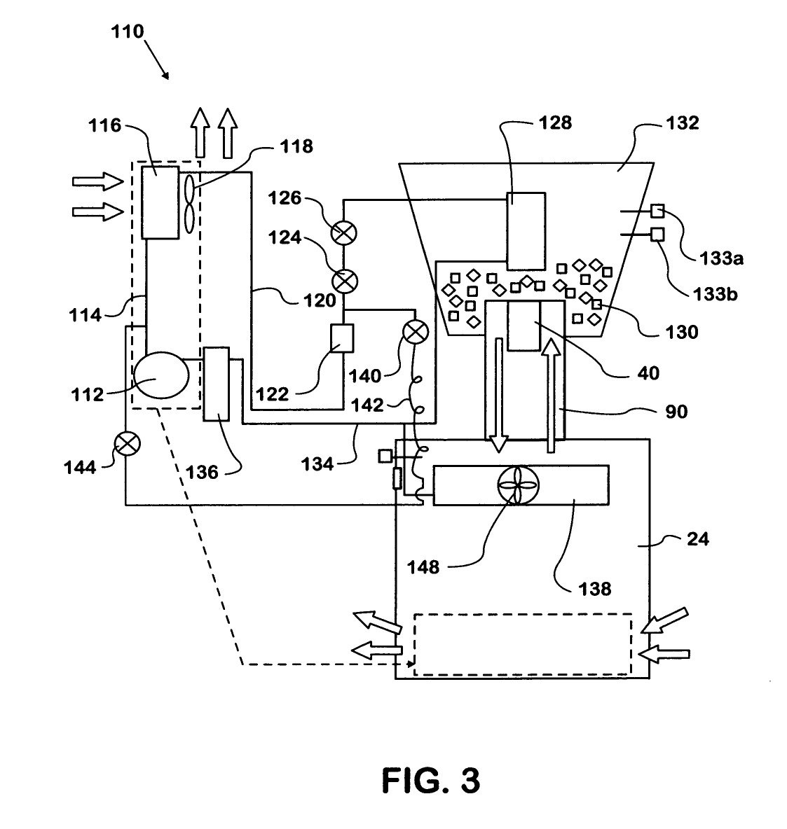

In the embodiment of refrigeration shown in FIG. 3 and indicated generally at 110, a single compressor and a single condenser are used to chill two evaporators, one for an icemaker and one in the lower cabinet 24. Hot refrigerant at a high side outlet from a compressor 112 is delivered through a refrigerant line 114 to an inlet to a condenser 116 through which air is drawn by a fan 118 to cool the refrigerant. Cooled refrigerant at an outlet from the condenser flows through a refrigerant line 120, a filter/dryer 122, a solenoid valve 124 and an expansion valve 126 to an inlet to an evaporator 128 of an icemaker to chill the evaporator to make ice pieces 130 that are introduced into an ice storage bin or hopper 132 contained in the upper cabinet 26 of the machine 20. Upper and lower thermostats 133a and 133b sense the level of ice in the bin and control the refrigeration system in the manner described in connection with FIG. 2 to maintain the level of ice in the bin between the levels of the thermostats. Refrigerant exiting the evaporator 128 flows through a refrigerant line 134 and an accumulator 136 to a suction inlet to the compressor 112. Ice manufactured by the icemaker for the bin is delivered into and dispensed in predetermined quantities from the chute 40 in making blended iced beverages.

A second evaporator 138 is in the lower cabinet 24 and has an inlet coupled to the outlet from the filter/dryer 122 through a solenoid valve 140 and a capillary 142 that serves as an expansion valve. An outlet from the evaporator 138 is coupled through the refrigerant line 134 and accumulator 136 to the suction inlet to the compressor 112. Ice can form on the evaporator 138, so to provide for defrost hot refrigerant from the high side outlet from the compressor is coupled through a solenoid valve 144 directly to the inlet to the evaporator. To chill the evaporator, with the compressor operating the solenoid valve 140 is opened and the solenoid valve 144 is closed. To warm and defrost the evaporator, with the compressor operating the solenoid valve 140 is closed and the solenoid valve 144 is opened.

The evaporator 138 chills air in the lower cabinet 24 to chill the supplies 28 of beverage ingredients stored in the cabinet. Pumps 92, valves 94 and tubing 96 (see FIG. 2) deliver beverage ingredients from the supplies through the conduit 90 extending between the lower cabinet and a point of delivery of the beverage ingredients in the upper cabinet 26 at the beverage ingredient dispense station 30. A fan 148 moves air through the evaporator 138 and through the conduit 90 to the point of delivery, which air is then returned through the conduit to the lower cabinet. The air flowing through the conduit is chilled to substantially the same temperature as the air in the lower cabinet, whereby beverage ingredients delivered through the conduit to the point of delivery are maintained chilled at about the same temperature as are the beverage ingredient supplies in the lower cabinet. Consequently, beverage ingredients are not allowed to warm in the conduit 90 and chilled beverage ingredients are always dispensed from the machine 20, even when the machine has been idle for a long time. If desired, the compressor and condenser can be located in a separate compartment in the bottom of the lower cabinet, as indicated by the dashed line rectangle, or they can be located atop the upper cabinet 26.

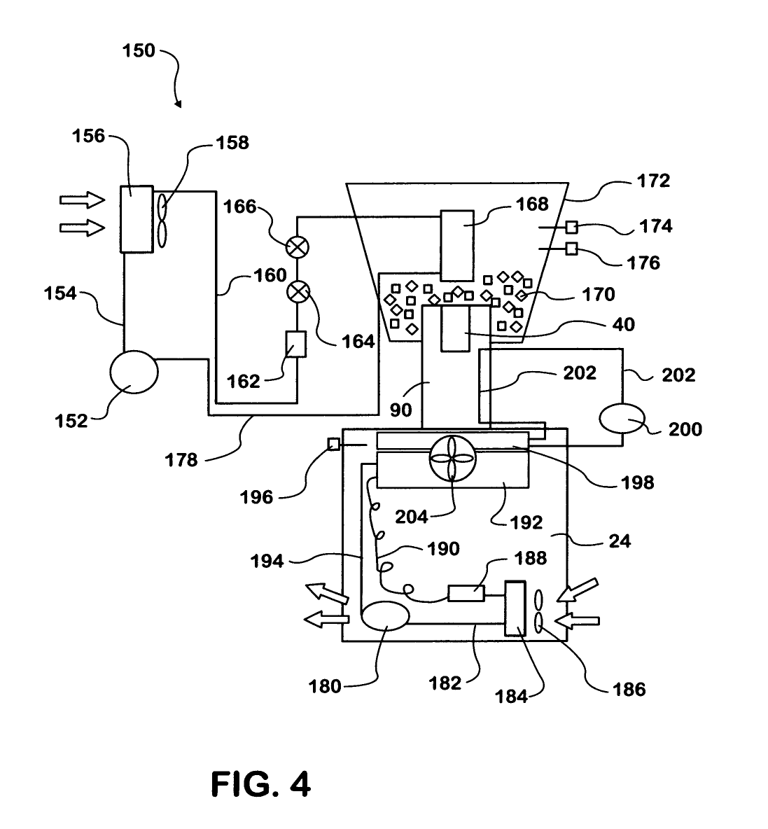

In the FIG. 4 embodiment the refrigeration system is indicated generally at 150 and two refrigeration systems are used, one to make ice for the bin and the other to chill the lower cabinet 24 and beverage ingredients as they are delivered through the conduit 90 from the lower cabinet to the point of delivery. The first refrigeration system includes a compressor 152 that delivers hot refrigerant from its high side outlet through a line 154 to a condenser 156 through which air is drawn by a fan 158 to cool the refrigerant. Cooled refrigerant exiting the condenser flows through a refrigerant line 160, a filter/dryer 162, a solenoid valve 164 and an expansion valve 166 to an inlet to an evaporator 168 of an icemaker that makes ice 170 for introduction into a bin 172. Upper and lower thermostats 174 and 176 sense the level of ice in the bin and control the icemaker to maintain the level between the levels of the thermostats, in a manner as described in connection with FIG. 2, and ice in the bin is delivered into the ice chute 40 from which predetermined quantities of ice are dispensed in the making of blended iced beverages. Refrigerant exiting the icemaker evaporator 168 returns through a line 178 to a suction inlet to the compressor 152.

The second refrigeration system is located in a separate compartment in the bottom of the machine lower cabinet 24 and includes a compressor 180, hot refrigerant at a high side outlet from which is delivered through a line 182 to a condenser 184 through which air is moved by a fan 186 to cool the refrigerant. Cooled refrigerant exiting the condenser flows through a filter dryer 188 and a capillary line 190 to an inlet to an evaporator 192 in the lower cabinet to chill the evaporator and thereby to chill air in the lower cabinet. Refrigerant exiting the evaporator returns through a line 194 to a suction inlet to the compressor 180. A thermostat 196 senses the temperature in the lower cabinet and controls operation of the compressor to maintain a selected temperature in the cabinet.

A heat exchanger 198 is in the lower cabinet 24 adjacent the evaporator 192 and includes at least one fluid circuit through which a heat transfer fluid, such as water, is flowed in a closed-loop water re-circulation circuit that includes a pump 200 and a water line 202. A fan 204 moves air chilled by the evaporator 192 both through the lower cabinet to assist in chilling the beverage ingredient supplies 28 and through the heat exchanger 198 to chill the heat exchanger and thereby chill water flowing through the heat exchanger circuit. The conduit 90 extends between the lower and upper cabinets 24 and 26 and beverage ingredients are delivered through tubing from the supplies in the lower cabinet and through the conduit to the point of delivery at the dispense station 30. To maintain the beverage ingredients in a chilled state as they are flowed to the point of delivery, the chilled water line 202 can pass through and be part of a python or tubing bundle through which beverage ingredients are flowed to the point of delivery, such that the water line is heat transfer coupled to the beverage ingredient conveying tubes to maintain the beverage ingredients chilled.

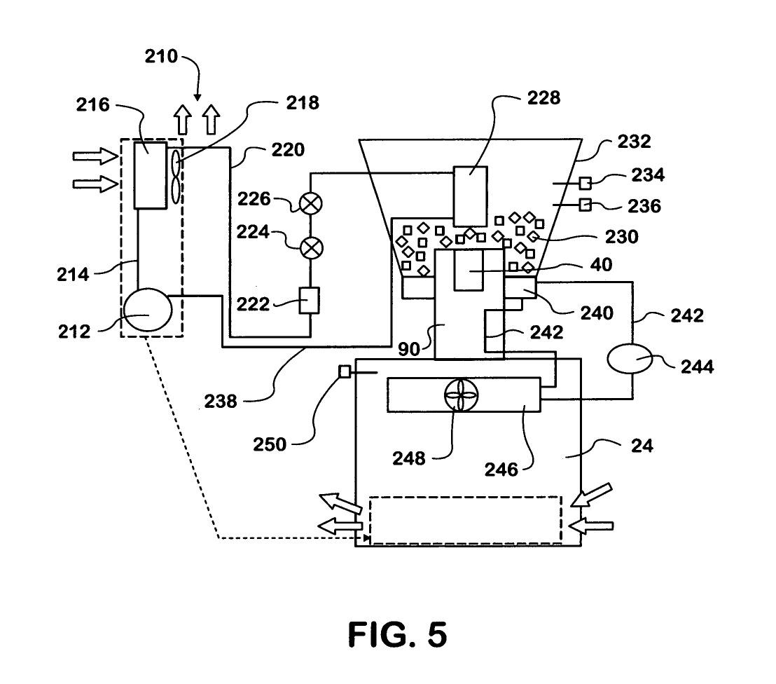

In the FIG. 5 embodiment a single refrigeration system, indicated generally at 210, is used for an icemaker that makes ice and the ice is used to chill both the lower cabinet 24 in which beverage ingredient supplies 28 are kept and beverage ingredients as they are delivered from the supplies and through the conduit 90 to the point of delivery of the ingredients at the dispense station 30. The refrigeration system includes a compressor 212, hot refrigerant at a high side outlet from which is delivered through a refrigerant line 214 to a condenser 216 through which air is moved by a fan 218 to cool the refrigerant. Cooled refrigerant exiting the condenser flows through a line 220, a filter/dryer 222, a solenoid valve 224 and an expansion valve 226 to an inlet to an icemaker evaporator 228 to make ice 230 for introduction into a bin 232. Upper and lower thermostats 234 and 236 control the refrigeration system to maintain the level of ice in the bin between the levels of the thermostats, and refrigerant exiting the evaporator 228 returns through a line 238 to a suction inlet to the compressor 212. Ice from the bin is delivered into the ice chute 40 for being dispensed in controlled quantities from the chute in the making of blended iced beverages.

A cold plate 240 is at the bottom of the bin 232 for being chilled by ice 230 in contact with it. The cold plate includes at least one water conveying circuit that is part of a closed-loop water re-circulation circuit that includes a water line 242, a pump 244 and at least one water conveying circuit of a heat exchanger 246 located in an upper portion of the lower cabinet 24. The heat exchanger 246 is chilled by cold water flowed through it and a fan 248 moves air through the heat exchanger to chill and circulate air through the lower cabinet 24 and conduit 90 to cool the lower cabinet and conduit. Chilling air in the lower cabinet and conduit chills and keeps cold the beverage ingredient supplies 28 in the lower cabinet and beverage ingredients as they are delivered through a tubing bundle from the supplies in the cabinet and through the conduit to the point of delivery. Alternatively and/or additionally, the chilled water line 242 of the water re-circulation circuit can be routed through a beverage ingredient conveying python or tubing bundle that extends through the conduit between the beverage ingredient supplies and the point of delivery in the upper cabinet 26 for chilling beverage ingredients in the python. If desired, the refrigeration system compressor and condenser can be located in a separate compartment in the lower cabinet, as indicated by the dashed line rectangle in the cabinet.

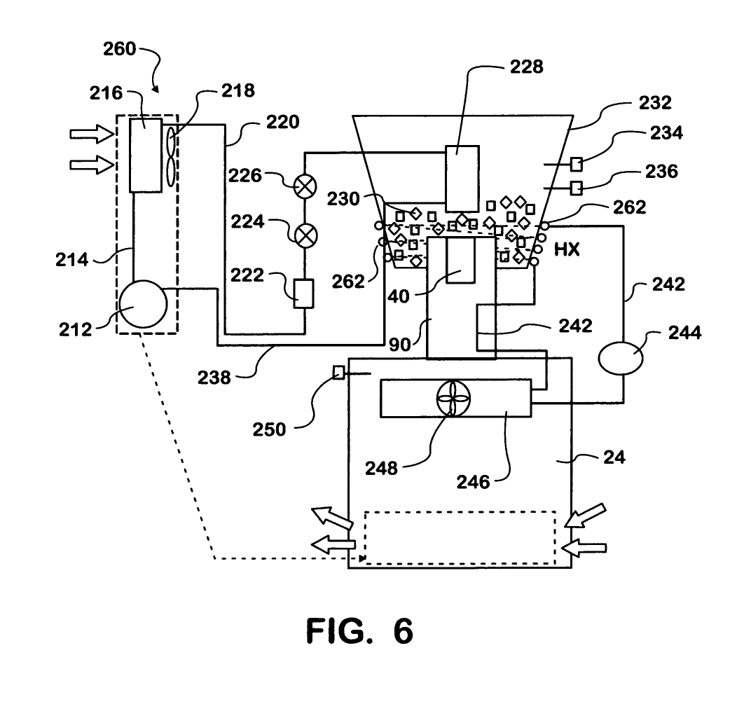

The refrigeration system of FIG. 6 is indicated generally at 260 and is similar to the one of FIG. 5, so like reference numerals have been used to denote like components. The difference between the FIGS. 5 and 6 refrigeration systems is that instead of using the cold plate 240 as in FIG. 5, in FIG. 6 a heat exchange coil 262 is used and is in heat exchange relationship with ice 230 in the bin 232 and part of the chilled water re-circulation circuit that includes the water line 242, the pump 244 and the heat exchanger 246 in the upper end of the lower cabinet 24. The coil 262 may be located in either the bin in direct contact with the bin ice or to the exterior of the bin in heat transfer coupled relationship through the bin with the ice.

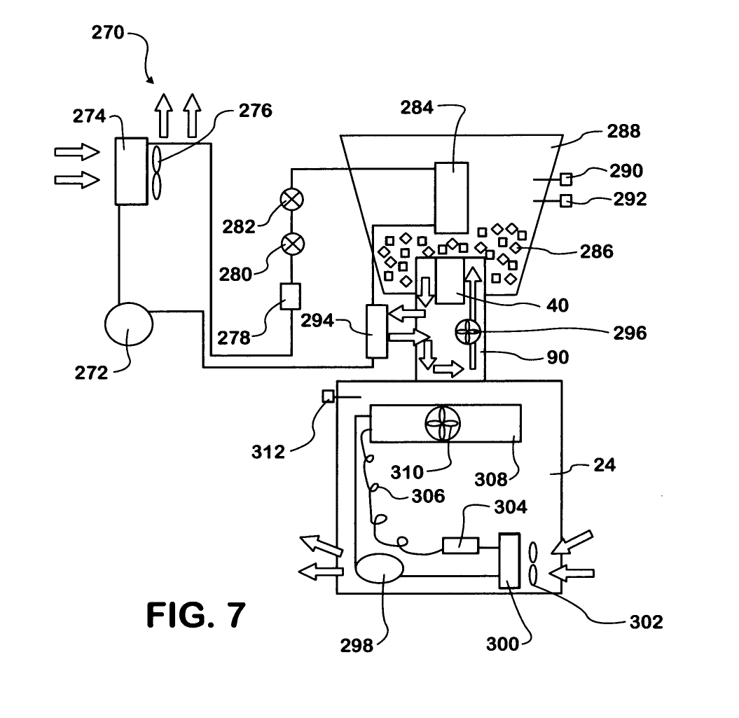

In the FIG. 7 embodiment of refrigeration system, indicated generally at 270, two separate refrigeration systems are used, one to make ice for the bin and chill air in the conduit 90 extending between the lower cabinet 24 and the point of delivery of beverage ingredients in the upper cabinet 26, and the other to chill the lower cabinet and beverage ingredient supplies 28 stored in the lower cabinet. The first refrigeration system includes a compressor 272 that delivers hot refrigerant from its high side outlet to a condenser 274 through which air is moved by a fan 276 to cool the refrigerant. Cooled refrigerant exiting the condenser is delivered through a filter/dryer 278, a solenoid valve 280 and an expansion valve 282 to an inlet to an icemaker evaporator 284. The icemaker makes ice 286 for an ice storage bin 288 and refrigerant exiting the icemaker evaporator 284 is delivered through a heat exchanger 294 to chill the heat exchanger before being returned to a suction inlet to the compressor 272. This chilling of the heat exchanger is used to chill air in the conduit 90 extending between the lower cabinet 24 and the point of delivery of beverage ingredients in the upper cabinet 26, and thereby beverage ingredients in the conduit as they are delivered from the supplies 28 in the lower cabinet through the conduit to the point of delivery. To this end, a fan 296 moves air through a re-circulation path that includes the heat exchanger 294 and the conduit 90, to chill the air as it flows through the heat exchanger and to thereby chill the interior of the conduit.

The second refrigeration system is used to cool the lower cabinet 24 includes a compressor 298, hot refrigerant at a high side outlet form which is delivered to a condenser 300 through which air is moved by a fan 302 to cool the refrigerant. Cooled refrigerant from the condenser is flowed through a filter/dryer 304 and a capillary 306 to an inlet to an evaporator 308 located toward the upper end of the lower cabinet, with refrigerant exiting the evaporator being returned to a suction inlet to the compressor. A fan 310 moves air through the evaporator to chill the air and circulates the chilled air throughout the lower cabinet to chill the beverage ingredient supplies 28 stored in the lower cabinet, and a thermostat 312 controls operation of the compressor to maintain a selected temperature in the lower cabinet. Beverage ingredients delivered from the supplies in the lower cabinet and through the conduit 90 to the point of delivery are thereby always kept cold. As is understood, the compressor 298, condenser 300 and fan 302 are thermally isolated from the interior of the lower cabinet within which the beverage ingredient supplies are kept.

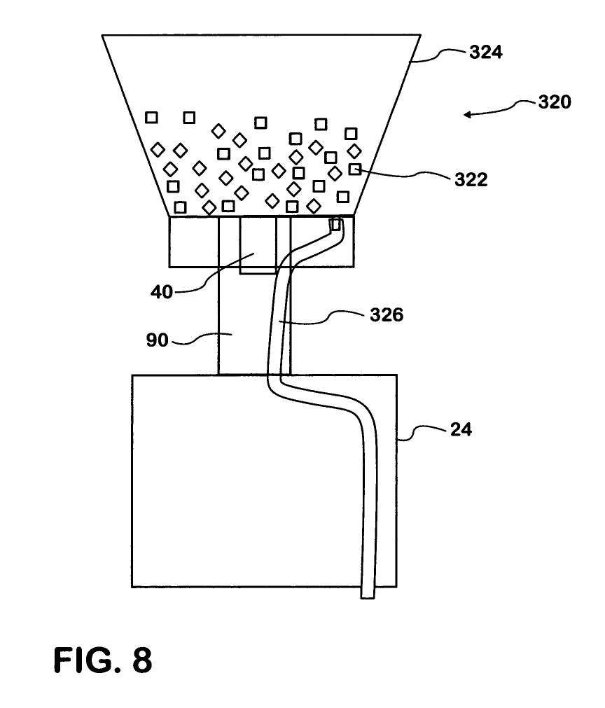

In the FIG. 8 embodiment at least one refrigeration system (not shown) is provided to make ice 322 for a bin 324 and to chill the beverage ingredient supplies 28 in the lower cabinet 24. To chill and maintain chilled beverage ingredients as they are delivered through the conduit 90 in a tubing bundle, cold melt water from ice in the bin is flowed through an ice melt water drain tube 326 that is routed within and heat transfer coupled to a beverage delivery tubes within the tubing bundle extending between the beverage ingredient supplies in the lower cabinet and the point of delivery in the upper cabinet 26. The drain tube 326 can pass through the lower machine cabinet and ice melt water exiting the tube is routed to a drain.

The invention therefore provides improved refrigeration systems for machines for making blended iced beverages, which refrigeration systems maintain beverage ingredients cold both as stored in a storage compartment of the machine and as delivered from the storage compartment to a remote point of delivery of the ingredients, even when the machine is idle for an extended period. While in the various embodiments ice is shown as being introduced into an ice storage bin by an icemaker, it is understood that ice can also be manually delivered into the bin.

While embodiments of the invention has been described in detail, various modifications and other embodiments thereof may be devised by one skilled in the art without departing from the spirit and scope of the invention, as defined in the appended claims.

What is claimed is:

1. An apparatus for making blended iced beverages, said apparatus comprising:
a housing having an upper cabinet, an ice storage bin in said upper cabinet, a beverage ingredient dispense station, a lower cabinet for storing supplies of beverage ingredients, and a conduit extending between said lower cabinet and a point of delivery of beverage ingredients in said upper cabinet;
an icemaker;
means separate from said conduit for delivering beverage ingredients from supplies thereof in said lower cabinet through said conduit to said point of delivery in said upper cabinet; and
a refrigeration system for operating said icemaker to make ice for said bin and for chilling said lower cabinet and said means for delivering along its path from the beverage ingredient supplies and through said conduit to the point of delivery, so that beverage ingredients are chilled and maintained chilled as they are delivered from the beverage ingredient supplies and through said conduit to said point of delivery.

2. Apparatus as in claim 1, wherein said refrigeration system comprises a cold plate in heat exchange relationship with ice in said bin, a heat exchanger in said lower cabinet, a closed-loop fluid circulation circuit that includes at least one circuit of said cold plate and at least one circuit of said heat exchanger, and a pump for circulating a heat transfer fluid through said closed-loop circuit to chill said fluid as it passes through said cold plate circuit and to then chill said heat exchanger as said fluid passes through said heat exchanger circuit, whereby said heat exchanger chills said lower cabinet and the supplies of beverage ingredients in said lower cabinet.

3. Apparatus as in claim 2, wherein said means for delivering comprises a tubing bundle and said closed-loop circuit is heat transfer coupled to said tubing bundle to chill said tubing bundle and beverage ingredients delivered thereby.

4. Apparatus as in claim 2, wherein said heat transfer fluid is water, and including means coupled to said closed-loop circuit for delivering chilled water from said closed-loop circuit to said point of delivery.

5. An apparatus as in claim 1, wherein said refrigeration system includes means for moving chilled air from said lower cabinet through said conduit to chill within said conduit said means for delivering and beverage ingredients delivered thereby.

6. Apparatus as in claim 1, wherein said refrigeration system comprises an evaporator for chilling air in said lower cabinet, and means for moving chilled air from said lower cabinet through said conduit to chill within said conduit said means for delivering and beverage ingredients delivered thereby.

7. Apparatus as in claim 1, wherein said refrigeration system comprises an evaporator for chilling air in said lower cabinet to chill the supplies of beverage ingredients therein, a heat exchanger having at least one fluid circuit, means for moving air chilled by said evaporator through said heat exchanger to chill said heat exchanger, a closed-loop heat transfer circulation circuit that includes said at least one circuit of said heat exchanger and a pump for circulating a heat transfer fluid through said closed-loop circuit, said means for delivering includes a tubing bundle extending from the supplies of beverage ingredients in said lower cabinet and through said conduit to said point of delivery, and said closed-loop circuit is heat transfer coupled to said tubing bundle within said conduit to chill said tubing bundle and beverage ingredients delivered thereby, whereby beverage ingredients are maintained chilled as they are delivered from the supplies thereof to said point of delivery.

8. Apparatus as in claim 1, wherein said refrigeration system comprises a cold plate chilled by ice in said bin and having at least one fluid circuit, a heat exchanger for chilling said lower cabinet and having at least one fluid circuit, and a closed-loop fluid circulation circuit that includes said at least said one circuit of said cold plate and said at least one circuit of said heat exchanger and a pump for circulating a heat transfer fluid through said closed-loop circuit, said means for delivering including a tubing bundle extending between the supplies of beverage ingredients in said lower cabinet and through said conduit to said point of delivery, said closed-loop circuit being heat transfer coupled to said tubing bundle within said conduit to chill said tubing bundle and beverage ingredients delivered thereby, whereby beverage ingredients are maintained chilled as they are delivered from the supplies thereof to said point of delivery.

9. Apparatus as in claim 1, wherein said refrigeration system comprises a coil heat transfer coupled to ice in said bin, a heat exchanger for chilling said lower cabinet and having at least one fluid circuit, and a closed-loop fluid circulation circuit that includes said coil and said at least one circuit of said heat exchanger and a pump for circulating a heat transfer fluid through said closed-loop circuit, said means for delivering including a tubing bundle extending between supplies of beverage ingredients in said lower cabinet and through said conduit to said point of delivery, said closed-loop circuit being heat transfer coupled to said tubing bundle to chill said tubing bundle within said conduit, whereby beverage ingredients are maintained chilled as they are delivered from the supplies thereof to said point of delivery.

10. Apparatus as in claim 1, wherein said refrigeration system comprises first and second refrigeration systems, said first refrigeration system operates said icemaker and includes a heat exchanger having at least one refrigerant flow circuit in-line with a refrigerant flow path from said icemaker for being chilled, and a fan for circulating air between said heat exchanger and said conduit to chill air in said conduit and thereby said beverage ingredient delivering means in said conduit, and said second refrigeration system having an evaporator for chilling said lower cabinet and the supplies of beverage ingredients in said cabinet, whereby beverage ingredients are always maintained chilled as they are delivered from the supplies thereof to said point of delivery.

11. Apparatus as in claim 1, wherein said means for delivering beverage ingredients includes a tubing bundle extending between the supplies of beverage ingredients and said point of delivery, and said refrigeration system includes an ice melt water drain line from said ice storage bin and heat transfer coupled to said tubing bundle to chill beverage ingredients in said tubing bundle.

12. A method of operating a blended iced beverage making machine that has an upper cabinet, an ice storage bin in the upper cabinet, a beverage ingredient dispense station, a lower cabinet for storing supplies of beverage ingredients, a conduit extending between the lower cabinet and a point of delivery of beverage ingredients in the upper cabinet, and an icemaker for making ice for the bin, said method comprising the steps of:
delivering beverage ingredients from the supplies thereof in the lower cabinet through beverage ingredient flow paths that are separate from and extend through the conduit to the point of delivery in the upper cabinet; and
using a refrigeration system to operate the icemaker to make ice for the bin and to chill the interior of the lower cabinet, the supplies of beverage ingredients in the lower cabinet and the beverage ingredient flow paths along their lengths from the beverage ingredient supplies and through the conduit to the point of delivery, so that beverage ingredients are chilled and maintained chilled as they are delivered from the beverage ingredient supplies to the point of delivery.

13. A method as in claim 12, wherein said step of using a refrigeration system comprises the steps of:
placing a cold plate having at least one fluid circuit in heat exchange relationship with ice in the bin;
placing a heat exchanger having at least one fluid circuit in the lower cabinet; and
flowing a heat transfer fluid through a closed-loop fluid circulation circuit that includes the at least one circuit of the cold plate and the at least one circuit of the heat exchanger to chill the fluid as it passes through the cold plate circuit and to then chill the heat exchanger as the fluid passes through the heat exchanger circuit, whereby the heat exchanger chills the lower cabinet and the supplies of beverage ingredients in the lower cabinet.

14. A method as in claim 12, wherein said step of using a refrigeration system includes the step of moving chilled air from the lower cabinet through the conduit to chill within the conduit the beverage ingredient flow paths and thereby the beverage ingredients.

15. A method as in claim 13, wherein said delivering step comprises the step of delivering beverage ingredients through flow paths comprising tubes of a tubing bundle and said step of using a refrigeration system includes the step of heat transfer coupling the closed-loop circulation circuit to the tubes of the tubing bundle to chill beverage ingredients delivered therethrough.

16. A method as in claim 13, wherein said flowing step comprises flowing water through the closed-loop circulation circuit, and including the step of delivering chilled water from the closed-loop circuit to the point of delivery.

17. A method as in claim 12, wherein said step of using a refrigeration system comprises the steps of chilling air in the lower cabinet, and flowing chilled air from the lower cabinet through the conduit to chill the beverage ingredient flow paths and thereby beverage ingredients being delivered through the conduit to the point of delivery.

18. A method as in claim 12, wherein said delivering step includes the step of flowing beverage ingredients through flow paths comprising tubes of a tubing bundle that extends from the supplies of beverage ingredients in the lower cabinet and through the conduit to the point of delivery, and said step of using a refrigeration system comprises the steps of chilling air in the lower cabinet to chill the supplies of beverage ingredients therein, using chilled air in the lower cabinet to chill a heat exchanger having at least one fluid circuit, flowing a heat transfer fluid through a closed-loop circulation circuit that includes the at least one circuit of the heat exchanger, and heat transfer coupling the closed-loop circuit to the tubes of the tubing bundle to chill the tubes and thereby beverage ingredients delivered through the tubes to the point of delivery.

19. A method as in claim 12, wherein said delivering step includes the step of delivering beverage ingredients from the supplies thereof to the point of delivery through flow paths comprising tubes of a tubing bundle that extends through the conduit, and said step of using a refrigeration system comprises the steps of placing a cold plate in heat exchange relationship with ice in the bin, providing a heat exchanger for chilling the lower cabinet, and establishing a closed-loop fluid circulation circuit that includes at least the one fluid circuit of the cold plate, at least one fluid circuit of the heat exchanger and at least one tube of the tubing bundle to chill the tubes of the tubing bundle and thereby the beverage ingredients in the tubes.

20. A method as in claim 12, wherein said step of using a refrigeration system comprises heat transfer coupling a coil to ice in said bin, providing a heat exchanger in and for chilling the lower cabinet and having at least one fluid circuit, and providing a closed-loop fluid circulation circuit that includes the coil and at least one circuit of the heat exchanger and a pump for circulating a heat transfer fluid through the closed-loop circuit, said delivering step including delivering beverage ingredients through tubes of a tubing bundle extending between supplies of beverage ingredients in the lower cabinet and through the conduit to the point of delivery, the closed-loop circuit being heat transfer coupled to the tubes of the tubing bundle to chill the tubes within the conduit, so that beverage ingredients are maintained chilled as they are delivered from the supplies thereof and through the conduit to the point of delivery.

21. A method as in claim 12, wherein said delivering step includes the step of delivering beverage ingredients from the supplies thereof to the point of delivery through flow paths comprising tubes of a tubing bundle that extends through the conduit, and said step of using a refrigeration system includes the step of heat transfer coupling an ice melt water drain line from the ice bin to the tubes of the tubing bundle to chill beverage ingredients in the tubing bundle.
